(19) United States
(12) Patent Application Publication
(10) Pub. No.: US 2021/0103929 A1
(43) Pub. Date: Apr. 8, 2021

(54) SYSTEMS AND METHODS FOR DEBT PREVENTION

(71) Applicant: Capital One Services, LLC, McLean, VA (US)

(72) Inventors: Lin Ni Lisa Cheng, Fresh Meadows, NY (US); Lea Cody, Arlington, VA (US); Vyjayanthi Vadrevu, Chicago, IL (US); Allison Rosenberg, Washington, DC (US); Abdelkader Benkreira, New York, NY (US)

(21) Appl. No.: 16/593,483

(22) Filed: Oct. 4, 2019

(51) Int. Cl. G06Q 20/40; G06Q 20/14; G06Q 40/02; G06Q 20/10

(52) U.S. Cl. CPC G06Q 20/4016; G06Q 20/102; G06Q 40/02; G06Q 20/14

(57) ABSTRACT

Systems and methods for debt prevention are disclosed. The system retrieves customer data for a customer and identifies account spending patterns from the customer data. The system also identifies current purchases from the customer data and compares the current purchases to the previous account spending patterns to determine an unusual spending pattern and/or an unusual purchase. The system further compares previous and current bill pay patterns from the customer data to determine a bill payment deviation. Next, the system compares previous and current customer engagement to determine any unusual customer engagement. The system then calculates a predicted payment risk based on any unusual customer engagement, unusual purchases, unusual spending patterns, and/or bill payment deviation. The system then determines one or more remediation tasks based on the payment risk and sends a request to the customer to choose and/or perform the desired remediation task.

### FIELD OF INVENTION

Examples of the present disclosure relate to systems and methods for debt prevention, and more particularly to systems and methods for identifying payment risk and providing customized, automated solutions to avoid the payment risk.

### BACKGROUND

Financial institutions (e.g., banks and/or credit card companies) provide various services to their customers including loans, credit cards, and bank accounts. Customers use these services to buy goods and services, pay bills, and manage debt, among other things. Of course, it is in the best interest of both the financial institution and the customer for the customer to pay their bills on-time. For customers, paying on-time can improve or maintain a customer's credit rating and can also help avoid late fees and compounding interest. Timely payment also reduces collection costs for financial institutions; and ultimately, financial institutions require repayment to remain solvent. Therefore, ensuring that customers can repay obligations is crucial.

At some point, however, a customer may experience financial difficulties causing late payments or missed payments. When this occurs, a customer may seek, or a financial institution may offer, various solutions including a waiver of late fees, debt forgiveness, an extended credit line, etc. And, while these solutions can help the customer, they may not be the best solution for the customer's situation. In some cases, these solutions may also be offered (or sought) too late in the process when the customer's credit score has already been lowered and/or debt accumulation has become unmanageable.

Identifying a payment risk for a customer in a timely manner (i.e., before it is too late) can be difficult for a number of reasons. In some cases, identifying risk is difficult simply because of the sheer amount of customer data (e.g., a single credit card company can have millions or tens of millions of customers and billions of transactions per year). In other cases, identifying risk can be difficult due to a lack of data. In other words, a credit card company may not have access to a customer's account data with other banks and credits cards, which makes it difficult to provide holistic solutions. Indeed, each customer has unique issues, which can lead to the payment risks, and which may require unique solutions.

Accordingly, there is a need for systems and methods that proactively predict payment risk for a customer and offer a customized solution tailored to the customer's needs. Examples of the present disclosure are directed to this and other considerations.

### SUMMARY

Examples of the present disclosure comprise systems and methods for debt prevention. The method can include retrieving, by one or more processors associated with a financial institution, customer data. The method can also include identifying, by the one or more processors executing a debt prevention algorithm, account spending patterns for a specific customer. The account spending patterns can include a frequency of previous purchases, an average amount of the previous purchases, a product type of the previous purchases over a certain time span, etc.

The method can also include the one or more processors identifying the current purchases and determining several risk factors. The risk factors can include whether the customer is engaging in an unusual spending pattern or if the customer made an unusual purchase, among other things. This can be determined by comparing the current purchases to the previous purchases, for example, to determine if the unusual spending pattern and/or unusual purchase exists.

The method can further include identifying previous bill pay patterns and current bill pay patterns from the customer data to determine whether another risk factor exists: a bill payment deviation. Also, the method can determine previous customer engagement and current customer engagement to identify another risk factor: unusual customer engagement. Unusual customer engagement can be based on a number of customer logins to an application and/or website associated with the financial institution, for example, a number of customer calls to the financial institution over a certain time period, etc.

Based on the existence of one or more risk factors (e.g., an unusual spending pattern, unusual purchase, a bill payment deviation, an unusual customer engagement, etc.), the one or more processors can calculate predicted payment risks for each customer. The one or more processors can then determine a remediation task (e.g., a refinancing option, a late fee waiver, debt forgiveness, an increased credit line, etc.) based on the predicted payment risk. The method can then send a request to a user device associated with the customer, which can include details about the remediation task and an option to approve or deny the remediation task or to choose between several remediation tasks. In some examples, the system can receive customer approval from the user device and then perform the remediation task. In other examples, the system can receive a denial from the user device, which may cause the one or more processors to update the debt prevention algorithm.

Further features of the disclosed design, and the advantages offered thereby, are explained in greater detail hereinafter with reference to specific examples illustrated in the accompanying drawings, wherein like elements are indicated be like reference designators.

### BRIEF DESCRIPTION OF THE DRAWINGS

Reference will now be made to the accompanying drawings, which are not necessarily drawn to scale, are incorporated into, and constitute a portion of, this disclosure, illustrate various implementations and aspects of the disclosed technology and, together with the description, serve to explain the principles of the disclosed technology. In the drawings:

FIG. 1 is a diagram of an example system that may be used to implement one or more examples of the present disclosure;

FIG. 2 is a flowchart of a method for debt prevention based on identified patterns within a customer's data, in accordance with some examples of the present disclosure;

FIGS. 3A-B are flowcharts of a method for debt prevention based on identified patterns within multiple customers' data, in accordance with some examples of the present disclosure;

FIG. 4 is a component diagram of an example of a user device, in accordance with some examples of the present disclosure; and

FIG. 5 is a component diagram of an example of a server, in accordance with some examples of the present disclosure.

### DETAILED DESCRIPTION

Examples of the present disclosure relate to systems and methods for debt prevention. The system can retrieve customer data and identify anomalies, or “predicted payment risks,” in the customer data. The system can compare current customer data to previous customer data to detect anomalies in customer behavior. The system can determine when an unusual spending pattern and/or an unusual purchase exists, for example, by comparing the current purchases to previous spending patterns for the account. The system can also determine whether a bill pay deviation exists by comparing the customer's current bill pay patterns to the previous bill patterns. Further, by comparing the current customer engagement to the previous customer engagement, the system can determine whether an unusual customer engagement exists. When one or more predicted payment risks are identified, the system can calculate a risk score and determine a remediation task to reduce the risk. The system can then send a request to the customer (e.g., to a user device) that includes details of one or more remediation tasks and an option to choose or deny the remediation task(s).

Some implementations of the disclosed technology will be described more fully with reference to the accompanying drawings. This disclosed technology, however, may be embodied in many different forms and should not be construed as limited to the implementations set forth herein. The components described hereinafter as making up various elements of the disclosed technology are intended to be illustrative and not restrictive. Many suitable components that could perform the same or similar functions as components described herein are intended to be embraced within the scope of the disclosed systems and methods. Such other components not described herein may include, but are not limited to, for example, components developed after development of the disclosed technology.

It is also to be understood that the mention of one or more method steps does not imply a particular order of operation or preclude the presence of additional method steps or intervening method steps between those steps expressly identified. Similarly, it is also to be understood that the mention of one or more components in a device or system does not preclude the presence of additional components or intervening components between those components expressly identified.

Reference will now be made in detail to example examples of the disclosed technology, examples of which are illustrated in the accompanying drawings and disclosed herein. Wherever convenient, the same references numbers will be used throughout the drawings to refer to the same or like parts.

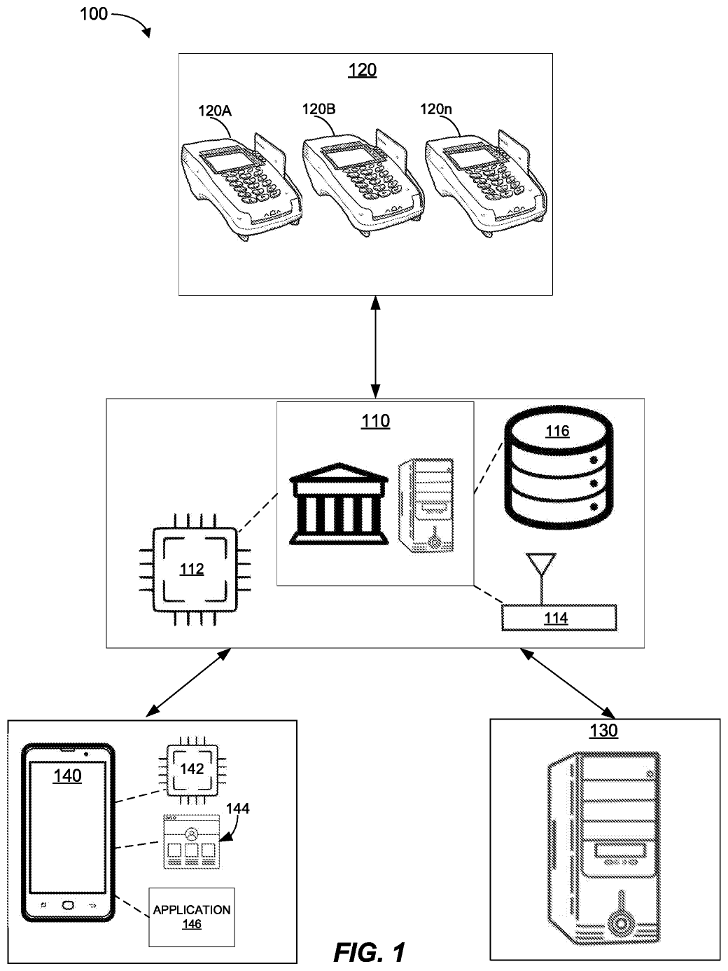

FIG. 1 shows an example system 100 that may implement certain methods for debt prevention as disclosed herein. As shown in FIG. 1, in some implementations the system 100 can include one or more point-of-sale (POS) devices 120A-120n, an external server 130, a user device 140, and a financial institution server 110, which may include one or more processors 112, a transceiver 114, and a database 116, among other things. The user device 140 can include one or more processors 142, a graphical user interface (GUI) 144, and an application 146. The POS devices 120A-120n may represent credit and/or debit card processing devices, automatic teller machines (ATMs), and other financial processing devices and may belong to various merchants, banks, credit card processing companies, etc. The external server 130 may belong to another financial institution, credit agency, an electronic payment system (EPS), or a third-party aggregator, for example, that stores customer data from various financial institutions, merchants, and even social media. The EPS may automatically process certain customer payments including recurring bills (e.g., water bill, power bill, etc.) without the use of a physical device—i.e., by accessing a payment method provided by the customer (e.g., debit card number, bank account number, etc.).

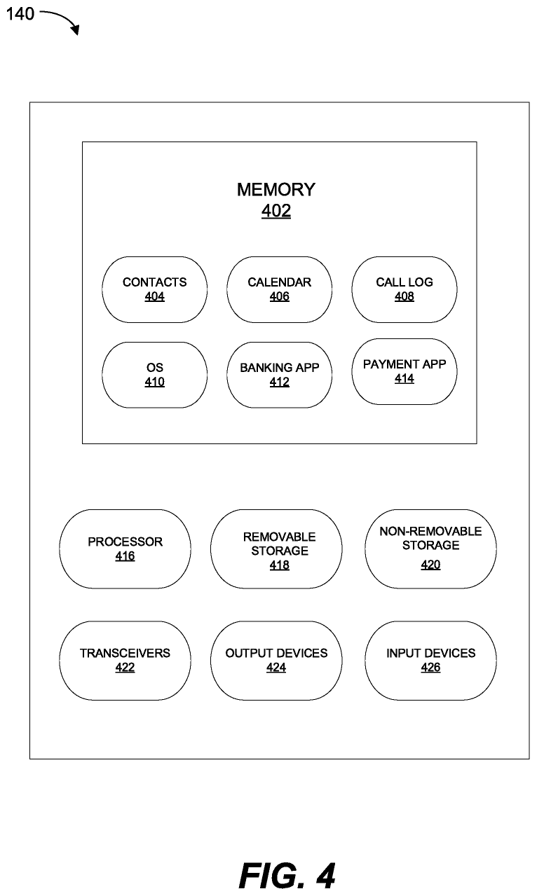

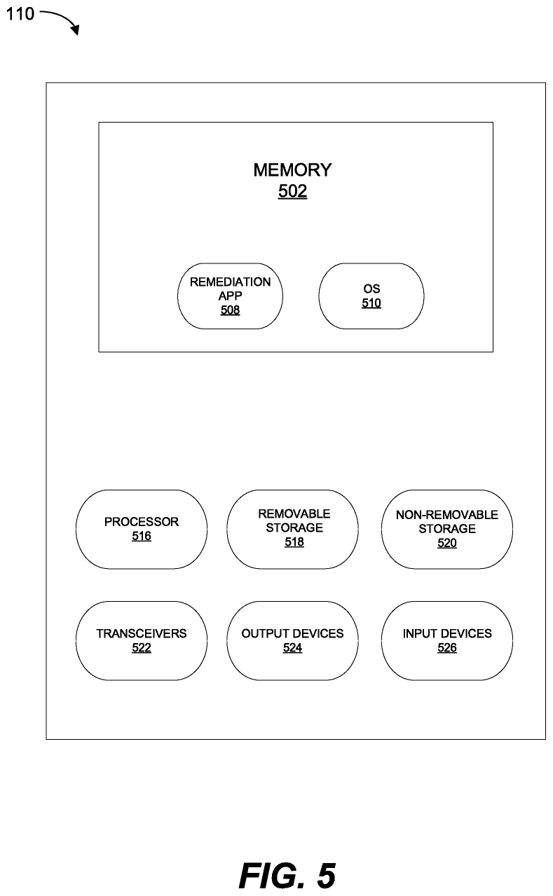

The user device 140 can be, for example, a personal computer, a smartphone, a laptop computer, a tablet, a wearable device (e.g., smart watch, smart jewelry, head-mounted displays, etc.), or other computing device. An example computer architecture that can be used to implement the user device 140 is described below with reference to FIG. 4. The financial institution server 110 can include one or more physical or logical devices (e.g., servers) or drives and may be implemented as a single server, a bank of servers (e.g., in a “cloud”), run on a local machine, or run on a remote server. An example computer architecture that can be used to implement the financial institution server 110 is described below with reference to FIG. 5.

To implement debt prevention, the financial institution server 110 can retrieve customer data, which can include first customer data (data for an individual first customer) and second customer data (data for a plurality of other customers). The customer data can be stored in the database 116 and can be received from a plurality of sources including external merchants and financial institutions (e.g., via POS devices 120A-120n) and/or from other external sources (e.g., the external server 130), associated with other financial institutions, credit reporting agencies, third-party bill pay services, etc. The customer data can include various fields that the financial institution server 110 can use to identify the first customer data and/or the second customer data including first and last name, a social security number, a customer mailing address, a unique identifier, account numbers, etc.

Next, the financial institution server 110 can determine whether any of several risk factors exist to help identify a predicted payment risk. The financial institution server 110 can use a debt prevention algorithm executed by the one or more processors 112 to identify one or more risk factors. The debt prevention algorithm can compare current customer data to previous customer data to detect changes in behavior. One of the risk factors the financial institution server can consider is whether the first customer has made any unusual purchases or had any unusual spending patterns. To do so, the financial institution server 110 can identify account spending patterns from the previous customer data for the first customer from the first customer data, which can include, for example, the frequency of previous purchases, the average amount of the previous purchases, and/or the product type of the previous purchases over a certain period of time (e.g., monthly, bi-monthly, semi-annually, or annually). The financial institution server 110 can also identify current customer data from the first customer data (e.g., purchases within the last three days, two weeks, three months, etc.). In some examples, the financial institution server 110 can also identify spending patterns for the plurality of customers from the second customer data.

Then, the financial institution server 110 can compare the current purchases to the spending patterns—for the first customer and/or the plurality of customers—to determine whether there is an unusual spending pattern and/or an unusual purchase. The first customer may average ten purchases per month in a particular category (e.g., groceries), for example, but the current purchases indicate thirty-five purchases in the last month. This discrepancy can cause the financial institution server 110 to determine that an unusual spending pattern exists. As another example, the account spending patterns indicate that the first customer purchased a refrigerator two months ago, yet the current purchases indicate the first customer purchased another refrigerator two weeks ago. Because the debt prevention algorithm identifies the refrigerator as a one-time purchase (e.g., once every five or ten years), the financial institution server can identify the second refrigerator purchase as an unusual purchase.

In some examples, the financial institution server may compare the current purchases to both the spending patterns for both the first customer and the plurality of customers to determine an unusual spending pattern and/or the unusual purchase. In this manner, the financial institution server 110 can learn other customers' spending patterns to better identify unusual spending patterns or unusual purchases for the first customer. This can be further refined by identifying customers most similar to the first customer based on demographics (e.g., income, education, ethnicity, marital status, location, etc.) included in the customer data and comparing those customers' account spending patterns (e.g., second account spending patterns) to the first customer's spending patterns (e.g., first account spending patterns).

Another risk factor that the financial institution server 110 can consider is whether a bill payment deviation exists. The financial institution server 110 can accomplish this by identifying previous bill pay patterns and comparing them to current bill pay patterns. This can include information concerning when payments are made, whether the payments are made on-time or late, whether each payment pays the full account balance, a minimum payment amount, or another amount, and/or a method of payment (e.g., debit card, check, credit card). Next, the financial institution server 110 can compare the current bill pay patterns to the previous bill pay patterns. When the current bill pay patterns vary (e.g., the previous bill pay patterns indicate payment at least three days before the payment due date and the current bill pay patterns indicate payment a week after the payment due date) from the previous bill pay patterns, the financial institution server 110 can determine a bill payment deviation exists.

The financial institution server 110 can also evaluate changes to automatically scheduled payments to detect a bill payment deviation before its occurrence. For example, the financial institution server 1100 can evaluate whether the customer turned off or changed scheduled auto-payments with the electronic payment system (e.g., external server 130) to determine a bill payment deviation. Of course, the financial institution server 110 can also determine a bill payment deviation when a scheduled payment with the electronic payment system is unsuccessful as result of insufficient funds and/or when the scheduled payment amount is changed.

In some examples, the bill payment deviation can also be assigned a mathematical value based on the percentage of deviation. If a bill payment is two weeks late for a bill that is paid monthly, for example, the percentage of deviation can be assigned as 0.5 out of 1 because the current bill pay patterns are 50% later than the previous bill pay patterns. Similarly, if a customer consistently pays their balance in full (i.e., 100% of the balance), but then switches to paying the minimum payment (e.g., 5% of the balance), the percentage of deviation can be 0.95, because the bill pay pattern is 95% lower than the previous bill pay pattern. In addition, the bill payment deviation can be determined as a factor of a factor—i.e., the percentage of deviation is multiplied by a weighted value. That is, the bill payment deviation can be calculated as above, but then further evaluated based on the customer's previous bill pay pattern. Therefore, in the prior example, the percentage of deviation of 0.5 for a monthly bill paid two weeks late can be adjusted on a customer-specific basis, such that the bill payment deviation is weighted higher (e.g., percentage of deviation multiplied by 1.3) for customers who routinely pay on time and weighted less for customers who routinely pay late (e.g., percentage of deviation multiplied by 0.7).

Current customer engagement for the first customer can be another risk factor used to identify predicted payment risk. Previous customer engagement for the first customer and/or the plurality of customers can be compared to the current customer engagement for the first customer to identify anomalies. The customer engagement can be based on a number of interactions with the financial institution, for example, a number of customer phone calls to the financial institution, a number of customer logins to the financial institution's website and/or application, or even the number of transactions completed with the financial institution in a predetermined time period. Of course, the current customer engagement can be based on more recent interactions (e.g., within a few days, weeks, or a month) with the financial institution, and the previous customer engagement can be based on customer interactions over a more extended period (e.g., a few months or a year). The financial institution server 110 can compare the current customer engagement to the previous customer engagement to determine whether an unusual customer engagement exists for the first customer, which can indicate a predicted payment risk.

In some examples, the financial institution server 110 can also analyze bank account(s), which can serve as another risk factor. The financial institution server 110 can receive, for example, customer data from the external server 130 (e.g., a financial institution where the first customer has a checking account) including recent deposits, deposit amounts, frequency of deposits, current and previous account balances, and/or withdrawals. Based on this data, the financial institution server 110 can determine whether the first customer has, or will have, insufficient funds to pay current and upcoming obligations, for example, which the customer may not recognize otherwise. Obviously, insufficient funds can indicate a current or future payment risk. Of course, other risk factors such as, for example, a change in credit rating, a large purchase (e.g., a new house or car), an unexpected medical bill, a tax lien, etc. can be used to identify payment risks.

Using one or more risk factors, the financial institution server 110 can calculate the predicted payment risk. Calculating the predicted payment risk can involve the financial institution server 110 assigning a weight to each of the determined the risk factors, calculating a risk score by totaling the respective weights of the risk factors, and then comparing the risk score to a risk scale to determine the appropriate remediation task. In other words, different remediation tasks may be chosen based on the severity of the predicted payment risk. The risk scale can comprise a score of 1-100, for example, where 1-25 represents a relatively low risk, 26-50 representing a higher risk, etc. Based on the level of risk, as indicated by the risk score, the financial institution server 110 can select, for example, a late fee waiver for risk scores between 1-25, extending a credit line or adding overdraft protection for risk scores between 26-50, refinancing for risk scores between 51-75, and loan forgiveness for risk scores between 76-100.

Of course, the risk score can include multiple risk factors and different financial institutions may place different weights on different risk factors. Credit card companies may assign a higher risk score to late payments, for example, because credit cards represent unsecured debt and because late payments often lead to defaults. A mortgage lender may assign a lower risk score for late payment, on the other hand, because the loan is secured by the property and because a default can result in the eviction of the customer (which the customer obviously wants to avoid). Similarly, extending a credit line may be more appropriate for a credit card company, while refinancing may be more useful for a mortgage or loan company.

The financial institution server 110 can also use demographic information to determine the remediation task. The financial institution server 110 can compare the demographic information of the first customer data to the demographic information of the second customer data to identify a second customer matching at least some of the demographic information of the first customer (e.g., the first and second customer are men between 25 and 30 years of age, located in Miami, single, have no children, and earn between $150K and $200K) Next, the financial institution server 110 can identify a previous predicted payment risk and a previous remediation task offered to the second customer, determine whether the previous remediation task prevented the predicted payment risk, and then set the previous remediation task as the remediation task for the first customer.

Once the predicted payment risk is determined and one or more remediation tasks have been identified, the financial institution server 110 can send the remediation task(s) to the user device 140. In some examples, the remediation task(s) can be sent as a request that includes details about the remediation task(s) and an option to approve a single remediation task, choose from multiple remediation tasks, or deny the remediation task(s) outright. In some examples, the request may provide options for the first customer to select the remediation task, for example, the request may offer the customer a choice of refinancing, extending a line of credit, or taking the late fee waiver.

When the financial institution server 110 receives approval of the remediation task from the user device 140, the financial institution server 110 can perform the remediation task. In some examples, the financial institution server 110 can automatically (i.e., without human intervention) implement the remediation task. So, if the customer agrees to accept an increase in credit line, for example, the financial institution server 110 can automatically update the credit line for the customer's account. In some examples, the financial institution server 110 can also update the debt prevent algorithm to favor that remediation task (e.g., increasing a line of credit) for that predicted payment risk (e.g., a late payment).

When the financial institution server 110 receives customer denial of the remediation task from the user device 140, on the other hand, the financial institution server 110 takes no action with respect to the customer's account, but can nonetheless update the debt prevention algorithm. The financial institution server 110 can rebalance the weights assigned to the factors leading to the predicted payment risk determination (e.g., the bill payment deviation and the unusual customer engagement), for example, which can dynamically adjust and improve the debt prevention algorithm based on customer feedback. In some examples, rather than having to send a confirmation request to the customer, the customer may grant permission to perform the remediation task automatically when the predicted payment risk is determined.

The request can be sent from the financial institution server 110 as an e-mail, short message service (SMS) message, and/or as instructions, that when received by the user device 140, cause the request to be displayed by the GUI 144. The customer can interact with the financial institution server 110 by using the application 146, for example, which can provide the remediation task and the details of the remediation task via the GUI 144 on the application 146. Thus, the customer can choose, approve, or deny the remediation task from the application 146 via the GUI 144 (e.g., on a touchscreen of the user device 140).

After the predicted payment risk is determined, the financial institution server 110 can receive new customer data that can be compared to the customer data to determine whether the predicted payment risk occurred. The occurrence of the predicted payment risk or the lack thereof can used by the financial institution server 110 to refine the debt prevention algorithm. In cases where the customer denies the remediation task and the predicted payment risk did not occur, the financial institution server 110 can analyze the new customer data to identify one or more actions taken by the customer that led to avoidance of the predicted payment risk. Once identified, the financial institution server 110 can include the one or more actions as one of the remediation tasks and update the debt prevention algorithm accordingly. In another case where the customer denies the remediation task and the predicted payment risk occurs, the financial institution server 110 can analyze the new customer data to identity one or more actions that further contributed to the predicted payment risk. The financial institution server 110 can then include the one or more actions as one of the risk factors and update the debt prevention algorithm.

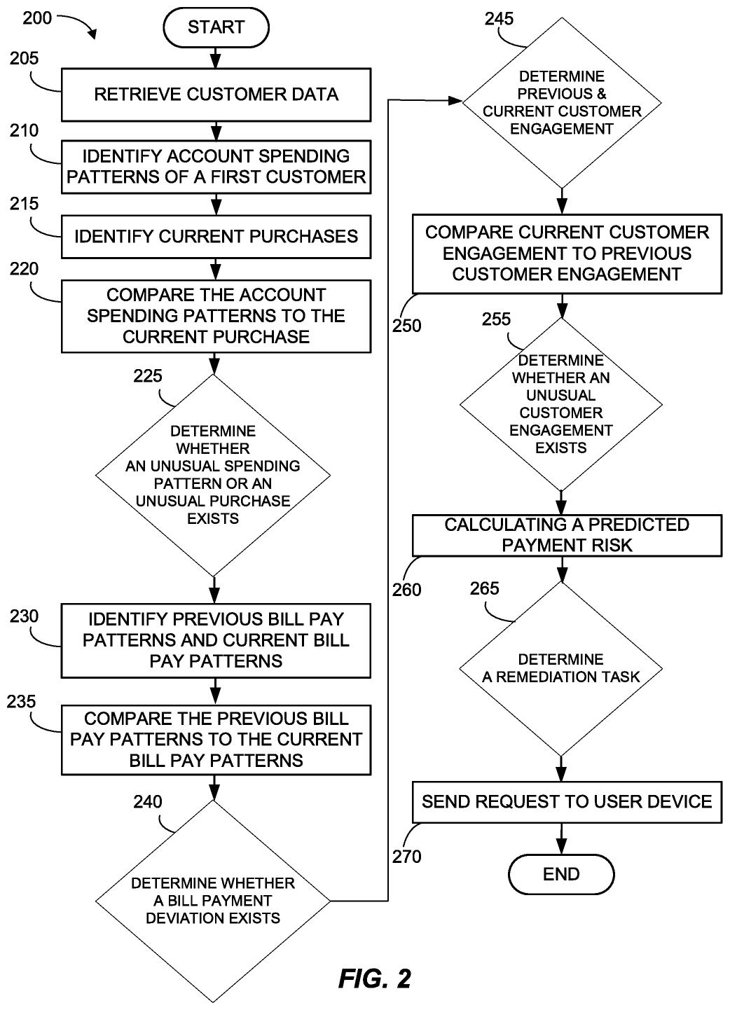

FIG. 2 is a flowchart of an example of a method 200 for debt prevention based on identified patterns within a customer's data from the perspective of the financial institution server 110. The method 200 can be performed by the financial institution server 110, the user device 140, the external server 130, the POS devices 120A-120n, or any combination thereof. The financial institution server 110 may be in communication with the user device 140, the POS devices 120A-120n, and the external server 130. Further, the financial institution server 110 can receive customer data from the external server 130 and/or the POS devices 120A-120n, calculate the predicted payment risk for a first customer, determine a remediation task, and send a request to the user device 140 to perform the remediation task.

At 205, the financial institution server 110 can retrieve customer data, which can be stored in the database 116. The customer data can be an aggregate of customer data received from a plurality of merchants (e.g., POS devices 120A-120n) and/or customer data received from the external server 130. As mentioned above, the customer data can include the first customer data for the first customer and second customer data for the plurality of customers. Therefore, the financial institution server 110 may need to parse the customer data to identify the first customer data. Once the first customer data is identified, the financial institution can evaluate several risk factors to help calculate the predicted payment risk.

At 210, the financial institution server 110, executing the debt prevention algorithm, can identify account spending patterns for the first customer from the customer data, which can include a frequency of previous purchases, an average amount of the previous purchases, a product category (e.g., one-time purchase, recurring payment, etc.), and/or a product type of the previous purchases over a predetermined period. At 215, the financial institution server 110 can identify current purchases for the first customer from the customer data, which can occur over a certain time span (e.g., a week or a month).

One of the risk factors that the financial institution server 110 can evaluate is whether there are any unusual spending patterns and/or unusual purchases. At 220, the financial institution server 110 can do this by comparing the current purchases to the account spending patterns to determine, at 225, whether the first customer's current purchases indicate an unusual spending pattern and/or an unusual purchase.

Another risk factor that the financial institution server 110 can evaluate is a bill payment deviation. At 230, the financial institution server 110 can identify previous bill pay patterns (e.g., frequency of payments (weekly, bi-weekly, or monthly), payment amount (full payment, minimum payment, or other payment amount), payment type (debit, credit, or check)) and current bill pay patterns from the customer data. Then, at 235, the financial institution server 110 can compare the previous bill pay patterns to the current bill pay patterns to determine, at 240, whether the bill payment deviation exists.

An unusual customer engagement is yet another risk factor that the financial institution server 110 can evaluate. At 245, the financial institution server 110 can determine the previous customer engagement and the current customer engagement from the customer data. Determining the customer engagement can be based on the number of customer interactions with the financial institution (e.g., a number of phone calls to the financial institution and/or a number of logins to the financial institution website and/or application). At 250, the financial institution server 110 can compare the current customer engagement to the previous customer engagement to determine, at 255, whether an unusual customer engagement exists. Customer engagement can be calculated as the total number of customer interactions with the financial institution, for example, in the last month, the customer logged in to the financial institution app ten times, logged in to the financial institution website five times, and called the financial institution twice. In this case, the current customer engagement (over a month time span) is seventeen. Of course, the interactions can be weighted because, for example, a phone call can involve wait times and speaking with several representatives, the financial institution server 110 can assign a higher weight to phone calls than logins. In some examples, the financial institution server 110 can also determine the length of the interactions and weight them accordingly. The customer engagement (current and previous customer engagement) can be determined according to any or all these scenarios. The amount of variance between the current customer engagement and the previous customer engagement that leads to a determination of the unusual customer engagement can be set by the financial institution (e.g., 25% or more).

At 260, the financial institution server 110 can calculate the predicted payment risk based on the risk factors (e.g., unusual spending pattern, unusual purchase, bill payment deviation, and/or unusual customer engagement). Determining the predicted payment risk can include assigning a respective weight to each of the risk factors and calculating a risk score based on the respective weights. At 265, the financial institution server 110 can determine a remediation task, which can involve comparing the risk score to a risk scale, and identifying the remediation task from the risk scale. For example, a risk score of 75 might fall within a refinancing option range (50-75). At 270, the financial institution server 110 can send a request to the user device 140 that includes the remediation task (e.g., the refinancing option), details about the remediation task (e.g., refinance percentage, term, penalties, etc.), and/or an option to approve or deny the remediation task.

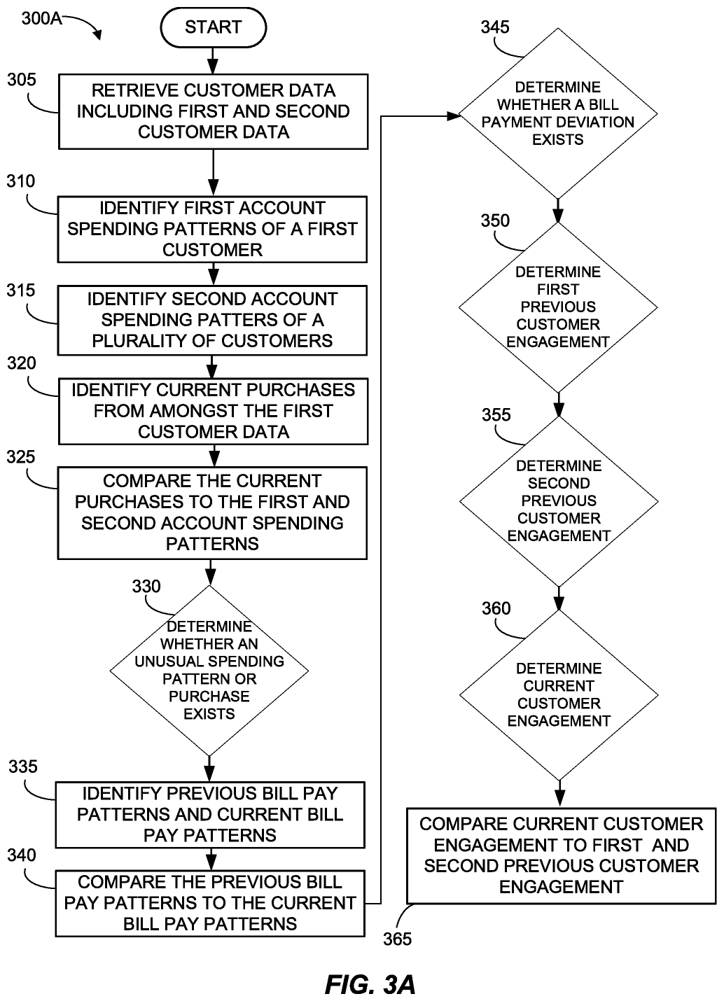

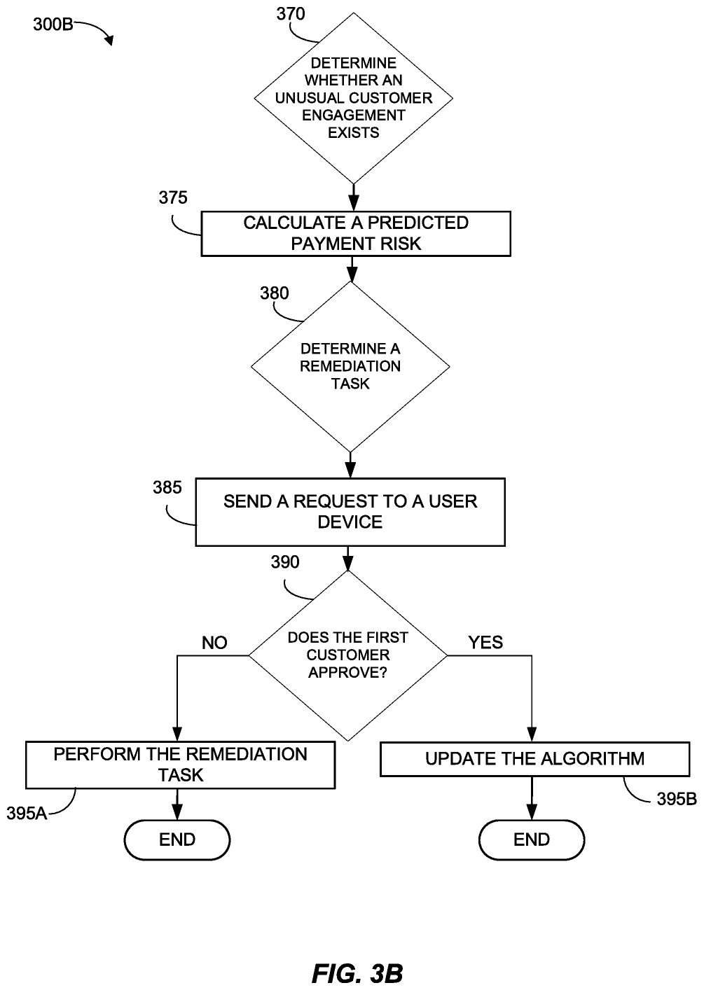

FIGS. 3A-B depict a flowchart of a method 300A and 300B for debt prevention based on identified patterns within multiple customers' data from the perspective of the financial institution server 110 that compares at least some the first customer data to some of the second customer data to calculate the predicted payment risk. The financial institution server 110 can receive customer data from the POS devices 120A-120n and/or the external server 130, which can be stored in the database 116. Further, as mentioned above, the financial institution server 110 can parse the customer data to identify first customer data for the first customer data and second customer data for the plurality of customers.

At 305, the financial institution server 110 can retrieve customer data including first customer data for the first customer and second customer data for the plurality of customers from the database 116. The financial institution server 110 can distinguish between the first customer data from the second customer data based on certain identifying fields within the customer data (e.g., a unique identifier). At 310, from the first customer data, the financial institution server 110 can identify first account spending patterns for the first customer over a certain time span. Similarly, at 315, the financial institution server 110 can identify the second account spending patterns for the plurality of the customers from the second customer data.

At 320, the financial institution server 110 can identify current purchases of the first customer from the first customer data, which can be purchases over a shorter time span (e.g., a week). At 325, the financial institution server 110 can compare the current purchases to the first account spending patterns and the second account spending patterns to determine, at 330, whether an unusual spending pattern and/or an unusual purchase exists. In other words, the financial institution server 110 can use both the first customer's typical spending patterns and other customers' typical spending patterns to determine whether the first customer's current purchases indicate a risk factor (e.g., unusual spending pattern).

At 335, the financial institution server 110 can identify previous bill pay patterns (e.g., type of bills paid, payment amount (in-full, minimum payment, or other amount), payment date, etc.) and current bill pay patterns from the first customer data. At 340, the previous bill patterns can be compared to the current bill pay patterns to determine, at 345, whether a bill payment deviation exists. As mentioned above, the bill payment deviation can be measured as a percentage of deviation of the current bill pay patterns from the previous bill pay patterns. In this case, a percentage of deviation of 25% can indicate the bill payment deviation.

At 350, the financial institution server 110 can determine first previous customer engagement for the first customer from the first customer data based on the number of first customer interactions with the financial institution. Similarly, at 355, the financial institution server 110 can determine the second previous customer engagement for the plurality of customers from the second customer data. The financial institution server 110 can also determine the current customer engagement (e.g., number of interactions with the financial institution over the last week) for the first customer from the first customer data at 360.

To determine another risk factor, an unusual customer engagement, the financial institution server 110 can compare the current customer engagement to the first previous customer engagement and the second previous customer engagement at 365. At 370, the financial institution server 110 can determine any unusual customer spending patterns (e.g., on average, over ten purchases per day during the last week) and/or any unusual purchases (e.g., a vacation to Italy).

Based on the risk factors (e.g., the unusual spending pattern, the unusual purchase, the bill payment deviation, the unusual customer engagement, and/or the insufficiency of funds), the financial institution server 110 can calculate the predicted payment risk at 375. At 380, the method can include determining the appropriate remediation task for the first customer based on the predicted payment risk, which can involve calculating a risk score and comparing the risk score to a risk scale to identify the remediation task. At 385, the financial institution server 110 can send a request to the user device 140 that can include the remediation task (e.g., loan forgiveness, overdraft protection, etc.), details about the remediation task (e.g., amount forgiven, requirement(s) to obtain loan forgiveness, etc.), and/or an option to approve or deny the remediation task. At 390, the financial institution server 110 can receive a response (e.g., SMS message) from the user device 140. At 395A, after receiving customer approval, the financial institution server 110 performs the remediation task.

At 395B, after receiving the response from the user device 140 denying the offered remediation task, the financial institution server 110 can update the debt prevention algorithm, such that going forward either a different remediation task can be offered, or that the financial institution server 110 determines that no remediation task is needed based on the predicted payment risk. In some examples, before updating the debt prevention algorithm, the financial institution server 110 can receive new first customer data, then compare the new customer data to the customer data to determine whether the predicted payment risk occurred. If the payment risk did not occur, the financial institution server 110 can update the debt prevention algorithm, such that the weights assigned to the risk factors are rebalanced. Further, in this scenario, the financial institution server 110 can monitor the first customer's actions after the predicted payment risk to learn the actions taken by the customer to avoid the payment risk, and incorporate those actions as a possible remediation task in a similar situation.

As shown in FIG. 4, some, or all, of the system 100 and methods 200, 300A and 300B can be performed by, and/or in conjunction with, the user device 140. In some examples, the user device 140 can comprise, for example, a cell phone, a smart phone, a tablet computer, a laptop computer, a desktop computer, a sever, or other electronic device. The user device 140 may be a single server, for example, or may be configured as a distributed, or “cloud,” computer system including multiple servers or computers that interoperate to perform one or more of the processes and functionalities associated with the disclosed examples. One of skill in the art will recognize, however, that the system 100 and methods 200, 300A and 300B can also be used with a variety of other electronic devices, such as, for example, tablet computers, laptops, desktops, and other network (e.g., cellular or internet protocol (IP) network) connected devices from which a call may be placed, a text may be sent, and/or data may be received. These devices are referred to collectively herein as the user device 140. The user device 140 can comprise a number of components to execute the above-mentioned functions and apps. As discussed below, the user device 140 comprise memory 402 including many common features such as, for example, contacts 404, a calendar 406, a call log (or, call history) 408, and OS 410. In this case, the memory 402 can also store a banking app 412 and a payment app 414.

The user device 140 can also comprise one or more processors 416. In some implementations, the processor(s) 416 can be a central processing unit (CPU), a graphics processing unit (GPU), or both CPU and GPU, or any other sort of processing unit. The user device 140 can also include one or more of removable storage 418, non-removable storage 420, one or more transceiver(s) 422, output device(s) 424, and input device(s) 426.

In various implementations, the memory 402 can be volatile (such as random-access memory (RAM)), non-volatile (such as read only memory (ROM), flash memory, etc.), or some combination of the two. The memory 402 can include all, or part, of the functions 404, 406, 408, 412, 414, and the OS 410 for the user device 140, among other things.

The memory 402 can also comprise contacts 404, which can include names, numbers, addresses, and other information about the user's business and personal acquaintances, among other things. In some examples, the memory 402 may also include a calendar 406, or other software, to enable the user to track appointments and calls, schedule meetings, and provide similar functions. In some examples, the memory 402 can also comprise the call log 408 of calls received, missed, and placed from the user device 140. As usual, the call log 408 can include timestamps for each call for use by the system 100. Of course, the memory 402 can also include other software such as, for example, e-mail, text messaging, social media, and utilities (e.g., calculators, clocks, compasses, etc.).

The memory 402 can also include the OS 410. Of course, the OS 410 varies depending on the manufacturer of the user device 140 and currently comprises, for example, iOS 12.1.4 for Apple products and Pie for Android products. The OS 410 contains the modules and software that supports a computer's basic functions, such as scheduling tasks, executing applications, and controlling peripherals.

As mentioned above, the user device 140 can also include the banking app 412. The banking app 412 can perform some, or all, of the functions discussed above with respect to the methods 200, 300A and 300B for interactions occurring between the user device 140 and the financial institution server 110. Thus, the banking app 412 can receive account information as well as the request that includes the remediation task, details about the remediation task, and the option to approve or deny the remediation task. The banking app 412 can also include an option that grants the financial institution server 110 permission to perform the remediation when the predicted payment risk is determined. Further, the banking app 412 can transmit the response to the remediation task to the financial institution server 110.

The user device 140 can also include the payment app 414. The payment app 414 can be associated with a debit card and/or credit card issued by a financial institution that allows payment from the user device 140 in place of the debit card or credit card. A user can select the payment app 414 on his phone, for example, and bring the phone within NFC range of one of the POS devices 120 (e.g., POS device 120A) to render payment with a merchant or with another user device.

The user device 140 can also include additional data storage devices (removable and/or non-removable) such as, for example, magnetic disks, optical disks, or tape. Such additional storage is illustrated in FIG. 4 by removable storage 418 and non-removable storage 420. The removable storage 418 and non-removable storage 420 can store some, or all, of the functions 404, 406, 408, 412, 414 and the OS 410.

Non-transitory computer-readable media may include volatile and nonvolatile, removable and non-removable tangible, physical media implemented in technology for storage of information, such as computer readable instructions, data structures, program modules, or other data. The memory 402, removable storage 418, and non-removable storage 420 are all examples of non-transitory computer-readable media. Non-transitory computer-readable media include, but are not limited to, RAM, ROM, electronically erasable programmable ROM (EEPROM), flash memory or other memory technology, compact disc ROM (CD-ROM), digital versatile disks (DVD) or other optical storage, magnetic cassettes, magnetic tape, magnetic disk storage or other magnetic storage devices, or any other tangible, physical medium which can be used to store the desired information and which can be accessed by the user device 140. Any such non-transitory computer-readable media may be part of the user device 140 or may be a separate database, databank, remote server, or cloud-based server.

In some implementations, the transceiver(s) 422 include any sort of transceivers known in the art. In some examples, the transceiver(s) 422 can include wireless modem(s) to facilitate wireless connectivity with the other user devices, the Internet, and/or an intranet via a cellular connection.

In other examples, the transceiver(s) 422 can include wired communication components, such as a wired modem or Ethernet port, for communicating with the other user devices or the provider's Internet-based network. In this case, the transceiver(s) 422 can also enable the user device 140 to communicate with the POS devices 120A-120n, the financial institution server 110, and the external server 130, as described herein.

In some implementations, the output device(s) 424 include any sort of output devices known in the art, such as a display (e.g., a liquid crystal or thin-film transistor (TFT) display), a touchscreen display, speakers, a vibrating mechanism, or a tactile feedback mechanism. In some examples, the output device(s) 424 can play various sounds based on, for example, whether the user device 140 is connected to a network, the type of call being received (e.g., video calls vs. voice calls), the number of active calls, etc. In some examples, the output device(s) can play a sound when the predicted payment risk is determined, the remediation task is performed, etc. Output device(s) 424 can also include ports for one or more peripheral devices, such as headphones, peripheral speakers, or a peripheral display.

In various implementations, input device(s) 426 can include any sort of input devices known in the art. The input device(s) 426 can include, for example, a camera, a microphone, a keyboard/keypad, or a touch-sensitive display. A keyboard/keypad may be a standard push button alphanumeric, multi-key keyboard (such as a conventional QWERTY keyboard), virtual controls on a touchscreen, or one or more other types of keys or buttons, and may also include a joystick, wheel, and/or designated navigation buttons, or the like.

As shown in FIG. 5, the system 100 and methods 200, 300A and 300B can also be used in conjunction with the financial institution server 110. The financial institution server 110 can comprise, for example, a desktop or laptop computer, a server, bank of servers, or cloud-based server bank. Thus, while the financial institution server 110 is depicted as single standalone servers, other configurations or existing components could be used.

In various implementations, the memory 502 can be volatile (such as random-access memory (RAM)), non-volatile (such as read only memory (ROM), flash memory, etc.), or some combination of the two. The memory 502 can include all, or part, of the functions of a remediation app 508, among other things. The memory 502 may also include the OS 510. Of course, the OS 510 varies depending on the manufacturer of the financial institution server 110 and the type of component. Many servers, for example, run Linux or Windows Server. The OS 510 contains the modules and software that supports a computer's basic functions, such as scheduling tasks, executing applications, and controlling peripherals.

The financial institution server 110 can also comprise one or more processors 516, which can include a central processing unit (CPU), a graphics processing unit (GPU), or both CPU and GPU, or any other sort of processing unit. The remediation app 508 can provide communication between the financial institution server 110 and the user device 140. Thus, the remediation app 508 can send the request to the user device 140 that includes the remediation task, details about the remediation task, and an option to approve or deny the remediation task. Also, the remediation app 508 can receive the response to the request from the user device 140. After receiving customer approval to perform the remediation task, the remediation app 508 can notify the customer (e.g. user device 140) when the remediation task is performed.

The financial institution server 110 can also include additional data storage devices (removable and/or non-removable) such as, for example, magnetic disks, optical disks, or tape. Such additional storage is illustrated in FIG. 5 by removable storage 518 and non-removable storage 520. The removable storage 518 and non-removable storage 520 may store some, or all, of the OS 510 and functions 508.

Non-transitory computer-readable media may include volatile and nonvolatile, removable and non-removable tangible, physical media implemented in technology for storage of information, such as computer readable instructions, data structures, program modules, or other data. The memory 502, removable storage 518, and non-removable storage 520 are all examples of non-transitory computer-readable media. Non-transitory computer-readable media include, but are not limited to, RAM, ROM, EEPROM, flash memory or other memory technology, CD-ROM, DVDs or other optical storage, magnetic cassettes, magnetic tape, magnetic disk storage or other magnetic storage devices, or any other tangible, physical medium which may be used to store the desired information, and which can be accessed by the financial institution server 110. Any such non-transitory computer-readable media may be part of the financial institution server 110 or can be a separate database, databank, remote server, or cloud-based server.

In some implementations, the transceiver(s) 522 include any sort of transceivers known in the art. In some examples, the transceiver(s) 522 may include wireless modem(s) to facilitate wireless connectivity with the user device 140, the Internet, and/or an intranet via a cellular connection. Further, the transceiver(s) 522 can include a radio transceiver that performs the function of transmitting and receiving radio frequency communications via an antenna (e.g., Wi-Fi or Bluetooth®). In other examples, the transceiver(s) 522 can include wired communication components, such as a wired modem or Ethernet port, for communicating with the other user devices or the provider's Internet-based network. The transceiver(s) 522, can receive customer data from the POS devices 120A-120n and/or the external server 130.

In some implementations, the output device(s) 524 include any sort of output devices known in the art, such as a display (e.g., a liquid crystal or thin-film transistor (TFT) display), a touchscreen display, speakers, a vibrating mechanism, or a tactile feedback mechanism. In some examples, the output devices may play various sounds based on, for example, whether the financial institution server 110 is connected to a network, the type of data being received (e.g., first customer data vs. second customer data), when the request is being transmitted, etc. Output device(s) 524 also include ports for one or more peripheral devices, such as headphones, peripheral speakers, or a peripheral display.

In various implementations, input device(s) 526 include any sort of input devices known in the art. For example, the input device(s) 526 can include a camera, a microphone, a keyboard/keypad, or a touch-sensitive display. A keyboard/keypad may be a standard push button alphanumeric, multi-key keyboard (such as a conventional QWERTY keyboard), virtual controls on a touchscreen, or one or more other types of keys or buttons, and may also include a joystick, wheel, and/or designated navigation buttons, or the like.

The specific configurations, machines, and the size and shape of various elements can be varied according to particular design specifications or constraints requiring a user device 140, financial institution server 110, POS devices 120A-120n, external server 130, system 100, or method 200, 300A, 300B constructed according to the principles of this disclosure. Such changes are intended to be embraced within the scope of this disclosure. The presently disclosed examples, therefore, are considered in all respects to be illustrative and not restrictive. The scope of the disclosure is indicated by the appended claims, rather than the foregoing description, and all changes that come within the meaning and range of equivalents thereof are intended to be embraced therein.

As used in this application, the terms “component,” “module,” “system,” “server,” “processor,” “memory,” and the like are intended to include one or more computer-related units, such as but not limited to hardware, firmware, a combination of hardware and software, software, or software in execution. For example, a component may be, but is not limited to being, a process running on a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Certain examples and implementations of the disclosed technology are described above with reference to block and flow diagrams of systems and methods and/or computer program products according to example examples or implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, may be repeated, or may not necessarily need to be performed at all, according to some examples or implementations of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks.

As an example, examples or implementations of the disclosed technology may provide for a computer program product, including a computer-usable medium having a computer-readable program code or program instructions embodied therein, said computer-readable program code adapted to be executed to implement one or more functions specified in the flow diagram block or blocks. Likewise, the computer program instructions may be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Certain implementations of the disclosed technology are described above with reference to user devices may include mobile computing devices. Those skilled in the art recognize that there are several categories of mobile devices, generally known as portable computing devices that can run on batteries but are not usually classified as laptops. For example, mobile devices can include, but are not limited to portable computers, tablet PCs, internet tablets, PDAs, ultra-mobile PCs (UMPCs), wearable devices, and smart phones. Additionally, implementations of the disclosed technology can be utilized with internet of things (IoT) devices, smart televisions and media devices, appliances, automobiles, toys, and voice command devices, along with peripherals that interface with these devices.

In this description, numerous specific details have been set forth. It is to be understood, however, that implementations of the disclosed technology may be practiced without these specific details. In other instances, well-known methods, structures, and techniques have not been shown in detail in order not to obscure an understanding of this description. References to “one embodiment,” “an embodiment,” “some examples,” “example embodiment,” “various examples,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrase “in one implementation” does not necessarily refer to the same implementation, although it may.

Throughout the specification and the claims, the following terms take at least the meanings explicitly associated herein, unless the context clearly dictates otherwise. The term “connected” means that one function, feature, structure, or characteristic is directly joined to or in communication with another function, feature, structure, or characteristic. The term “coupled” means that one function, feature, structure, or characteristic is directly or indirectly joined to or in communication with another function, feature, structure, or characteristic. The term “or” is intended to mean an inclusive “or.” Further, the terms “a,” “an,” and “the” are intended to mean one or more unless specified otherwise or clear from the context to be directed to a singular form. By “comprising,” “containing,” or “including” it is meant that at least the named element, or method step is present in article or method, but does not exclude the presence of other elements or method steps, even if the other such elements or method steps have the same function as what is named.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

While certain examples of this disclosure have been described in connection with what is presently considered to be the most practical and various examples, it is to be understood that this disclosure is not to be limited to the disclosed examples, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain examples of the technology and also to enable any person skilled in the art to practice certain examples of this technology, including making and using any apparatuses or systems and performing any incorporated methods. The patentable scope of certain examples of the technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

### Example Use Case

The following example use case describes an example of a use of the systems and methods for debt prevention described herein. It is intended solely for explanatory purposes and not to limit the disclosure in any way.

Fred's wife, Lisa, recently lost her job, and the two of them share bills and have joint accounts. Typically, Fred pays in full weeks before the payment due date on the household bills (e.g., previous bill pay patterns) that are his responsibility. Without Lisa's income, however, Fred is struggling to pay all the household bills. Luckily, Fred recently signed up for a service (e.g., the debt prevention algorithm) that his bank offers.

The service is designed to proactively prevent debt by analyzing each individual's customer data to identify factors that may lead to debt, including missed payments, late fees, interest charges and penalties, etc. One of the factors that the bank's service identifies is that rather than paying his bills in full and in advance of the payment due date, Fred has been paying the minimum payment on the payment due date for the last two months (e.g., current bill pay patterns). The bank's service notices that this is unusual (e.g., a bill pay deviation) for Fred. The bank's service also identifies the fact that Fred has paid a power bill for the first time (e.g., unusual purchase), a bill that was previously handled by Lisa. The new power bill payments coupled with the change in his bill pay pattern leads the bank's service to calculate that Fred is at risk for one or more missed payments (e.g., predicted payment risk).

The bank's service then analyzes Fred's overall financial situation and considers several ways to help his particular situation. Based on the fact that Fred seems to be short on cash, the system determines that an extended credit line may help Fred “get over the hump” until Lisa can find new employment. Fred receives a notification (e.g., a request) via the bank's app on his phone informing him that he may be at risk for missed payments and that the bank would like to offer an extended credit line with no interest for six months. Fred accepts the extended credit line and is able to avoid the missed payments using his new credit line. Later, when Lisa finds a new job, the two are able to pay back the extended credit line, while avoiding late payment fees and a negative effect to their credit scores.

1. A method for debt prevention comprising:
retrieving, with a transceiver of a financial institution server, customer data;
identifying, by one or more processors of the financial institution server executing a debt prevention algorithm, account spending patterns for a customer from the customer data, the account spending patterns comprising one or more of a frequency of previous purchases, an average amount of the previous purchases, and a product type of the previous purchases over a predetermined period;
identifying, by the one or more processors, current purchases from the customer data;
comparing, by the one or more processors, the current purchases to the account spending patterns to identify an unusual spending pattern or an unusual purchase;
identifying, by the one or more processors, previous bill pay patterns from the customer data;
identifying, by the one or more processors, current bill pay patterns from the customer data;
comparing, by the one or more processors, the previous bill pay patterns to the current bill pay patterns to identify a bill payment deviation, the bill payment deviation corresponding to a mathematical value determined by calculating a percentage deviation, wherein the calculation comprises selecting a percentage associated with a partial payment of a respective bill amount, selecting a percentage associated with a late payment of the respective bill amount, or both, and multiplying the selected percentage with a weighting factor associated with a frequency of late payments or partial payments corresponding to the previous bill pay patterns;
determining, by the one or more processors, previous customer engagement from the customer data based at least on a number of customer logins over the predetermined period, a number of customer calls over the predetermined period, or both;
identifying, by the one or more processors, current customer engagement from the customer data;
comparing, by the one or more processors, the current customer engagement to the previous customer engagement to identify any unusual customer engagement;
calculating, by the one or more processors, a predicted payment risk based on the determination of at least one of: the unusual spending pattern, the unusual purchase, the bill payment deviation, or the unusual customer engagement;
determining, by the one or more processors, a first remediation task from a set of remediation tasks based on the predicted payment risk, wherein the set of remediation tasks comprise at least one of: a refinance, a late fee waiver, a loan forgiveness, overdraft protection, or an increase to a credit line; and
sending, with the transceiver, a request to a user device associated with the customer comprising details about the first remediation task and an option to approve or deny the first remediation task.

2. The method of claim 1, wherein retrieving the customer data further comprises at least one of:
receiving, at the transceiver, customer data from an external merchant; or
receiving, at the transceiver, customer data from another financial institution.

3. The method of claim 1, further comprising:
receiving, at the transceiver, customer denial to perform the first remediation task from the user device;
receiving, at the transceiver, new customer data for the customer;
comparing, by the one or more processors, the new customer data to the customer data to determine that the predicted payment risk did not occur;
identifying, by the one or more processors, at least one action from the new customer data;
determining, by the one or more processors, that the at least one action prevented the predicted payment risk; and
updating, by the one or more processors, the debt prevention algorithm to include the at least one action in the set of remediation tasks.

4. The method of claim 1, further comprising:
receiving, at the transceiver, customer approval to perform the first remediation task from the user device; and
performing, by the one or more processors, the first remediation task.

5. The method of claim 1, wherein calculating the predicted payment risk further comprises:
assigning, by the one or more processors, a respective weight to at least one of: the unusual spending pattern, the unusual purchase, the bill payment deviation, or the unusual customer engagement; and
calculating, by the one or more processors, a risk score by totaling the respective weights.

6. The method of claim 5, wherein determining the first remediation task further comprises:
comparing, by the one or more processors, the risk score to a risk scale; and
identifying the first remediation task from the set of remediation tasks based on the risk scale.

7. The method of claim 5, further comprising:
receiving, at the transceiver, customer denial to perform the first remediation task from the user device; and
updating, by the one or more processors, the debt prevention algorithm to reduce the respective weight of at least one of: the unusual spending pattern, the unusual purchase, the bill payment deviation, or the unusual customer engagement.

8. The method of claim 1,
wherein the request further comprises a set of selections comprising two or more remediation tasks, the method further comprising:
receiving, at the transceiver, customer approval and a first selection from the set of selections; and
performing, by the one or more processors, the first remediation task associated with the first selection.

9. A method for debt prevention comprising:
retrieving, with a transceiver of a financial institution server, customer data, the customer data comprising first customer data for a first customer and second customer data for a plurality of customers;
identifying, by one or more processors of the financial institution server executing a debt prevention algorithm, first account spending patterns for the first customer from the first customer data;
identifying, by the one or more processors, second account spending patterns for the plurality of customers from the second customer data;
identifying, by the one or more processors, current purchases from the first customer data;
comparing, by the one or more processors, the current purchases to the first account spending patterns and the second account spending patterns to identify an unusual spending pattern or an unusual purchase;
identifying, by the one or more processors, previous bill pay patterns from the first customer data;
identifying, by the one or more processors, current bill pay patterns from the first customer data;
comparing, by the one or more processors, the previous bill pay patterns to the current bill pay patterns to identify a bill payment deviation, the bill payment deviation corresponding to a mathematical value determined by calculating a percentage deviation, wherein the calculation comprises selecting a percentage associated with a partial payment of a respective bill amount, selecting a percentage associated with a late payment of the respective bill amount, or some combinations thereof, and multiplying the selected percentage with a weighting factor associated with a frequency of late payments or partial payments corresponding to the previous bill pay patterns;
determining, by the one or more processors, first previous customer engagement from the first customer data based at least on one of: a number of first customer logins over a predetermined period or a number of first customer calls over the predetermined period;
determining, by the one or more processors, second previous customer engagement from the second customer data based at least on one of: a number of second customer logins over the predetermined period or a number of second customer calls over the predetermined period;
determining, by the one or more processors, current customer engagement from the first customer data;
comparing, by the one or more processors, the current customer engagement to the first previous customer engagement and the second previous customer engagement to identify any unusual customer engagement;
calculating, by the one or more processors, a predicted payment risk based on the determination of at least one of: the unusual spending pattern, the unusual purchase, the bill payment deviation, or the unusual customer engagement;
determining, by the one or more processors, a first remediation task from a set of remediation tasks based on the predicted payment risk, wherein the set of remediation tasks comprise at least one of: a refinance, a late fee waiver, a loan forgiveness, overdraft protection, or an increase to a credit line; and
sending, with the transceiver, a request to a user device associated with the first customer comprising details about the first remediation task and an option to approve or deny the first remediation task.

10. The method of claim 9, wherein the customer data further comprises demographic information comprising first demographic information for the first customer and second demographic information for the plurality of customers.

11. The method of claim 10, wherein determining the first remediation task further comprises:
retrieving, with the transceiver, a set of second customers with a previous predicted payment risk from the customer data, the previous predicted payment risk matching the predicted payment risk;
comparing, by the one or more processors, the first demographic information to the second demographic information to identify a second customer having second demographic information matching at least a portion of the first demographic information;
identifying, by the one or more processors, a previous remediation task offered to the second customer;
determining, by the one or more processors, that the previous remediation task prevented the previous predicted payment risk; and
setting, by the one or more processors, the previous remediation task as the first remediation task.

12. The method of claim 9, further comprising:
receiving, at the transceiver, customer approval to perform the first remediation task from the user device; and
performing, by the one or more processors, the first remediation task.

13. The method of claim 9, wherein calculating the predicted payment risk further comprises:
assigning, by the one or more processors, a respective weight to at least one of: the unusual spending pattern, the unusual purchase, the bill payment deviation, or the unusual customer engagement; and
calculating, by the one or more processors, a risk score by totaling the respective weights.

14. The method of claim 13, wherein determining the first remediation task further comprises:
comparing, by the one or more processors, the risk score to a risk scale; and
identifying the first remediation task from the set of remediation tasks based on the risk scale.

15. The method of claim 13, further comprising:
receiving, at the transceiver, customer denial to perform the first remediation task from the user device; and
updating, by the one or more processors, the debt prevention algorithm to reassign the respective weight of at least one of: the unusual spending pattern, the unusual purchase, the bill payment deviation, or the unusual customer engagement.

16. The method of claim 9, further comprising:
receiving, at the transceiver, customer denial to perform the first remediation task from the user device;
receiving, at the transceiver, new first customer data for the first customer;
comparing, by the one or more processors, the new first customer data to the first customer data to determine that the predicted payment risk did not occur;
identifying, by the one or more processors, at least one action from the new first customer data;
determining, by the one or more processors, that the at least one action prevented the predicted payment risk; and
updating, by the one or more processors, the debt prevention algorithm to include the at least one action in the set of remediation tasks.

17. The method of claim 9, wherein retrieving the customer data further comprises:
receiving, at the transceiver, customer data from at least one external merchant; or
receiving, at the transceiver, customer data from another financial institution.

18. A system for debt prevention comprising:
one or more processors;
a transceiver; and
memory, in communication with the one or more processors and the transceiver, storing a debt prevention algorithm that, when executed, cause the system to:
retrieve, with the transceiver, customer data for a customer;
receive, at the transceiver, customer approval to perform remediation;
identify, by the one or more processors, current customer data from previous customer data;
compare, by the one or more processors, the current customer data to the previous customer data to identify at least one risk factor from a set of risk factors;
calculate, by the one or more processors, a predicted payment risk based on the at least one risk factor comprising a bill payment deviation, the bill payment deviation corresponding to a mathematical value determined by calculating a percentage deviation, wherein the calculation comprises selecting a percentage associated with a partial payment of a respective bill amount, selecting a percentage associated with a late payment of the respective bill amount, or some combinations thereof, and multiplying the selected percentage with a weighting factor associated with a frequency of late payments or partial payments corresponding to the previous bill pay patterns;
determine, by the one or more processors, a first remediation task from a set of remediation tasks based on the predicted payment risk; and
perform, by the one or more processors, the first remediation task.

19. The system of claim 18, wherein the system is further configured to:
receive, at the transceiver, new customer data for the customer;
compare, by the one or more processors, the new customer data to the customer data to determine that the predicted payment risk occurred;
identify, by the one or more processors, at least one action from the new customer data;
determine, by the one or more processors, that the at least one action caused the predicted payment risk; and
update, by the one or more processors, the debt prevention algorithm to include the at least one action in the set of risk factors.

20. The system of claim 18, wherein determining the first remediation task further comprises:
assigning, by the one or more processors, a respective weight to each risk factor in the set of risk factors, the set of risk factors comprising an unusual spending pattern, an unusual purchase, and an unusual customer engagement;
calculating, by the one or more processors, a risk score by totaling the respective weights.
comparing, by the one or more processors, the risk score to a risk scale; and
identifying the first remediation task from the set of remediation tasks based on the risk scale.
